(19) United States
(12) Patent Application Publication
(10) Pub. No.: US 2003/0216212 A1
(43) Pub. Date: Nov. 20, 2003

(54) Interaxle differential control system

(75) Inventor: Reno Antonio Rodeghiero, Hudson, IA (US)

Correspondence Address: Joel S. Carter, Patent Department, DEERE & COMPANY, One John Deer Place, Moline, IL, 61265-8098, US

(73) Assignee: Deer & Company, a Delaware Corporation

(21) Appl. No.: 10/151,348

(22) Filed: May 20, 2002

(51) Int. Cl. F16H 48/04

(52) U.S. Cl. 475/295

(57) ABSTRACT

A tractor has an interaxle differential which transmits torque from an engine driven transmission to a front axle and to a rear axle. A differential includes a planetary gear set coupled to a modulating clutch. The modulating clutch is coupled between a pair of the planetary gear elements, and is used to bring the front to rear speed differential within desired limits. A control system for controlling the clutch includes a steering angle sensor, a front wheel speed sensor and a rear wheel speed sensor. From these sensors the control system determines a desired maximum speed difference between the front and rear wheels, and controls the differential to keep the front to rear speed ratio within the desired limit.

### BACKGROUND OF THE INVENTION

The present invention relates to a control system for an interaxle differential.

In tractors with mechanical front wheel drive and Ackerman steering it is desirable for the front wheels to rotate faster than the rear wheels when the tractor is turning, in order to achieve a tighter turn radius and better pulling performance during a turn. This can be accomplished with a differential between the front and rear axles. On agricultural tractors, such a differential is typically geared to divide the torque on a 30-70 basis between the front and rear wheels, and maintains this split regardless of wheel speed. One problem with such a system, is that if the front or rear wheels lose traction during heavy operation, the front or rear wheels may excessively slip, even to the point of stopping the tractor.

### SUMMARY

Accordingly, an object of this invention is to provide a system for controlling a differential between the front and rear axles which prevents excessive wheel slippage.

This and other objects are achieved by the present invention, wherein a system for controlling a differential between the front and rear axles includes a steering angle sensor, a front wheel speed sensor and a rear wheel speed sensor. From these sensors the control system determines an optimum speed ratio between the front and rear wheels, and controls a differential modulating clutch to achieve this optimum speed ratio.

### BRIEF DESCRIPTION OF THE DRAWINGS

FIG. 1 is a simplified schematic diagram of a differential control system of the present invention;

FIG. 2 is a look up table of steering angles and corresponding desired front/rear wheel speed differences.

### DETAILED DESCRIPTION

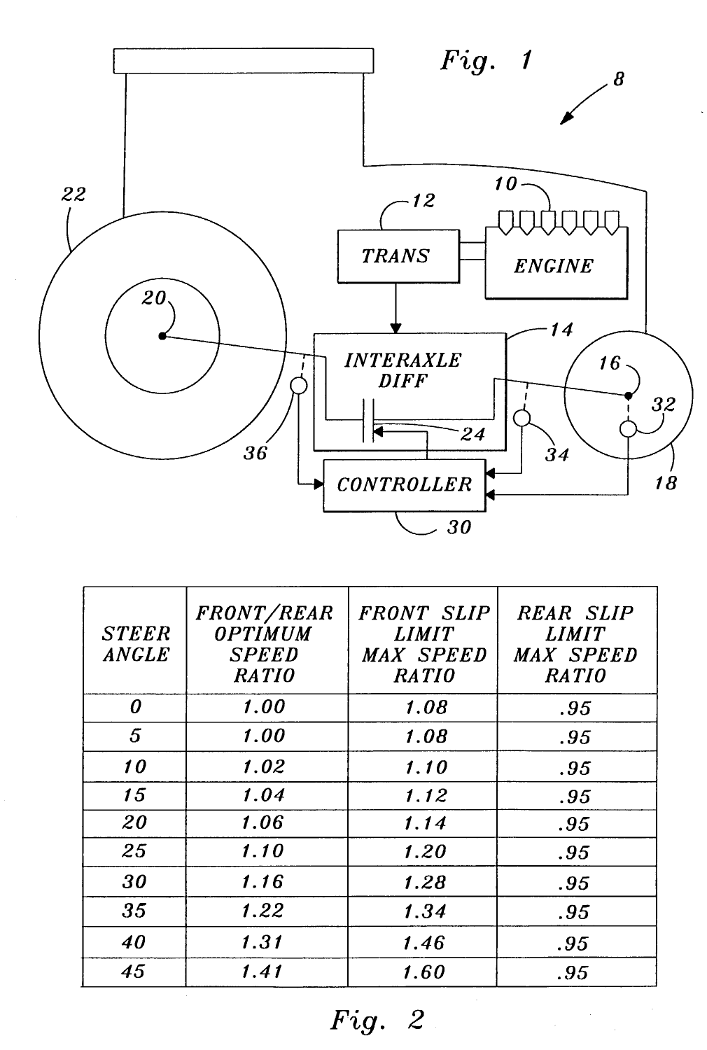

With reference to FIG. 1, a tractor 8 has an engine 10 which drives a transmission 12. An interaxle differential 14 transmits torque from transmission 12 to a front axle 16 and front wheels 18, and to a rear axle 20 and rear wheels 22. Differential 14 includes a planetary gear set (not shown) which receives torque from the transmission 12 and distributes the torque to the front and rear wheels 18, 22. Differential 14 also includes a modulating or lockup clutch 24 which can modulate the front-to-rear torque split from the (30-70) design proportion to a full lockup condition wherein there is no differential action.

A control unit 30 receives a steering angle signal from steering angle sensor 32, a front wheel speed signal from front wheel speed sensor 34 and a rear wheel speed signal from rear wheel speed sensor 36. Control unit 30 provides a control signal to clutch 24, and the control signal is determined as a function of the sensed steering angle and whether or not the front 18 or rear wheels 22 are turning at the desired speed in relation to each other. For example, the control unit 30 could have a lookup table stored in a memory therein, as illustrated by FIG. 2, or a angle versus differential speed relationship.

Referring now to FIG. 2, for each of a plurality of steering angle values in the first column, the table includes a second column with corresponds to the theoretical optimal front to rear speed ratio. If the measured front to rear wheel speed ratio is greater than optimal, then the front wheels have excessive slip. Column 3 of FIG. 2 establishes the allowable limit of front wheel slip. Once the front wheel slip exceeds the limit, the differential clutch 24 engages with just enough torque to bring the front to rear speed ratio to within the slip limit.

If the measured front to rear speed ratio is less than the optimal amount, then the rear wheels have excessive slip. Column 4 of FIG. 2 establishes the allowable limit of rear wheel slip. If the rear wheel slip exceeds the limit, the clutch 24 engages with just enough torque to bring the front to rear speed ratio with in the slip limit.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. In a vehicle having steerable front wheels, an interaxle differential for transmitting torque to front wheels and to rear wheels, the differential having a controllable device operable to control a ratio of front wheel speed to rear wheel speed, a control system comprising:
a steering angle sensor for generating a steering angle signal representing a steering angle of the front wheels, and
a control unit for controlling the controllable device as a function of the sensed steering angle.

2. The control system of claim 1, wherein:
the control unit controls the controllable device so that said speed ratio increases in response to an increase in steering angle.

3. The control system of claim 1, wherein:
the device comprises a modulating clutch.

4. The control system of claim 1, further comprising:
a front wheel speed sensor for generating a front wheel speed signal;
a rear wheel speed sensor for generating a rear wheel speed signal;
the control unit controls the device in response to sensed steering angle and sensed wheel speed.

5. The control system of claim 1, further comprising:
a front wheel speed sensor for generating a front wheel speed signal;
a rear wheel speed sensor for generating a rear wheel speed signal;
the control unit determines front wheel slip from the speed sensors and controls the controllable device to increase said speed ratio in response to an increase in front wheel slip.

6. The control system of claim 1, further comprising:
a front wheel speed sensor for generating a front wheel speed signal;
a rear wheel speed sensor for generating a rear wheel speed signal;
the control unit determines rear wheel slip from the speed sensors and controls the controllable device to increase said speed ratio in response to an increase in rear wheel slip.

7. In a vehicle having steerable front wheels, an interaxle differential for transmitting torque to front wheels and to rear wheels, the differential having a controllable modulating clutch which is operable to control a ratio of front wheel speed to rear wheel speed, a control system comprising:
a steering angle sensor for generating a steering angle signal representing a steering angle of the front wheels,
a front wheel speed sensor for generating a front wheel speed signal;
a rear wheel speed sensor for generating a rear wheel speed signal; and
a control unit for controlling the clutch as a function of the sensed signals.
